(19) United States
(12) Patent Application Publication
(10) Pub. No.: US 2024/0110934 A1
(43) Pub. Date: Apr. 4, 2024

(54) AUTOSAMPLER SYSTEM WITH MULTI-LUMEN PROBE

(71) Applicant: Elemental Scientific, Inc., Omaha, NE (US)

(72) Inventors: Andrew Kavan, Omaha, NE (US); Aaron Williams, Omaha, NE (US)

(21) Appl. No.: 18/480,880

(22) Filed: Oct. 4, 2023

Related U.S. Application Data
(60) Provisional application No. 63/413,058, filed on Oct. 4, 2022.

(51) Int. Cl. G01N 35/00; B01L 3/02

(52) U.S. Cl. CPC G01N 35/0099; B01L 3/0237

(57) ABSTRACT

Systems and methods for providing multiple lumens within a single sample probe of an autosampler system are described. In an aspect, a sample probe for an autosampler system includes, but is not limited to, a tube enclosing at least a portion of a plurality of lumens; and a controller communicatively coupled with a fluid handling system to introduce or draw one or more fluids through each of the plurality of lumens, wherein during a droplet purge operation, the controller is configured to expel a gas from a tip of one of the lumens to purge a droplet of fluid from the tip.

### CROSS-REFERENCE TO RELATED APPLICATION

The present application claims priority under 35 U.S.C. § 119(e) of U.S. Provisional Application Ser. No. 63/413,058, filed Oct. 4, 2022, and titled “AUTOSAMPLER SYSTEM WITH MULTI-LUMEN PROBE.” U.S. Provisional Application Ser. No. 63/413,058 is herein incorporated by reference in its entirety.

### BACKGROUND

In many laboratory settings, it is often necessary to analyze a large number of chemical or biochemical samples during limited time periods. In order to streamline such processes, the manipulation of samples has been mechanized. Such mechanized sampling is commonly referred to as autosampling and is performed using an automated sampling device or autosampler.

### SUMMARY

Systems and methods for providing multiple lumens within a single sample probe of an autosampler system are described. In an aspect, a sample probe for an autosampler system includes, but is not limited to, a tube enclosing at least a portion of a plurality of lumens; and a controller communicatively coupled with a fluid handling system to introduce or draw one or more fluids through each of the plurality of lumens, wherein during a droplet purge operation, the controller is configured to expel a gas from a tip of one of the lumens to purge a droplet of fluid from the tip.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DRAWINGS

The Detailed Description is described with reference to the accompanying figures. The use of the same reference numbers in different instances in the description and the figures may indicate similar or identical items.

FIG. 1 is an isometric view of an autosampler system for providing multiple lumens within a single sample probe in accordance with an example embodiment of the present disclosure.

FIG. 2 is a cross-sectional view of the sample probe of FIG. 1 in accordance with an example embodiment of the present disclosure.

FIG. 3 is a schematic diagram of an autosampler system for providing multiple lumens within a single sample probe in accordance with an example embodiment of the present disclosure.

FIG. 4A is a cross-sectional view of a liquid sample held in a sample container.

FIG. 4B is a cross-sectional view of the sample container of FIG. 4A with a sample probe of the present disclosure inserted and dispensing a second liquid into the sample container.

FIG. 4C is a cross-sectional view of the sample container and sample probe of FIG. 4B with the sample probe introducing a gas to mix the liquid sample and the second liquid.

FIG. 4D is a cross-sectional view of the sample container and sample probe of FIG. 4C with a mixed prepared sample.

FIG. 5A is a cross-sectional view of a sample probe including multiple lumens following a sample draw operation in accordance with an example embodiment of the present disclosure.

FIG. 5B is a cross-sectional view of the sample probe of FIG. 5A during a droplet purge operation in accordance with an example embodiment of the present disclosure.

FIG. 6 is a cross-sectional view of a sample probe including multiple lumens in an offset configuration in accordance with an example embodiment of the present disclosure.

FIG. 7 is a cross-sectional view of a sample probe including multiple lumens in an angled configuration in accordance with an example embodiment of the present disclosure.

### DETAILED DESCRIPTION

Overview

An automated sampling device, or autosampler, can support a sample probe relative to a vertically-oriented rod which moves the sample probe along or across one or more directions of movement. For instance, the sample probe can be coupled to a vertically-moveable portion of the rod by a probe support arm or other device to move the probe in a vertical direction, such as to position the probe into and out of sample vessels (e.g., vials, tubes, bottles, or other containers), rinse vessels, standard chemical vessels, diluent vessels, and the like, on a deck of the autosampler. In other situations, the rod can be rotated to facilitate movement of the probe about a horizontal plane, such as to position the probe above other sample vessels and other vessels positioned on the deck.

Sample vessels positioned on the deck can be supported by sample racks or sample holders to position the sample vessels in discrete positions for access by the sample probe. The sample probe is moved from sample vessel to sample vessel according to a programmed procedure to automatically introduce the sample probe into the sample vessels to draw samples out and direct the samples to a sample analysis system. The samples can be manipulated prior to analysis, such as through diluting the sample, introducing a standard to the sample, introducing a reactant to the sample, or the like, where the sample is typically mixed to ensure a substantially uniform sample prior to analysis. However, such procedures to introduce fluids and the subsequent mixing operations add time and cost to prepare the samples, which can affect throughput and accuracy of a laboratory operation. Laboratory procedures that add seconds or minutes to the time taken to prepare a sample can waste hours for labs handling hundreds of samples. For example, the wasted time can involve autosampler transitions involved in moving a probe to a fluid source, filling the probe, moving the probe to a sample vessel, introducing the fluid, mixing the fluid and the sample, rinsing the probe, moving another probe to the sample vessel, drawing the mixed sample, and the like.

Further, using an autosampler probe to draw samples from a sample vessel can add a contamination risk to other samples present on the sample deck as the probe moves from the sample vessel to another location (e.g., to a rinse station, to another sample vessel, etc.). For example, liquid adhering to external and internal surfaces of the sample probe can form droplets at the tip of the sample probe, which can pose a contamination risk should the droplet fall during transit of the sample probe (e.g., moving from the sample vessel to a rinse station, or the like). For instance, the sample probe can vibrate due to mechanical friction of moving components, motor operation, or the like, which can cause the droplets to fall into exposed sample vessels or onto the autosampler deck and splash into sample vessels, thereby contaminating the samples held in those vessels. Further, for systems that handle corrosive or otherwise hazardous sample materials, having droplets exposed to the environment outside the sample probe or sample vessels can pose safety risks to laboratory personnel.

Accordingly, systems and methods are disclosed for providing multiple lumens within a single sample probe to facilitate fluid introduction to samples, sample mixing, sample droplet purging, or combinations thereof. In an aspect, a sample probe includes an outer tube housing two or more lumens, each configured to couple with one or more fluid sources. The fluid sources can store diluents, chemical standards, reactive additives, pressurized gases (e.g., for mixing, for reactions, etc.), surfactant additives, matrix modifier fluids, sample matrix additives, or the like. The sample probe can be introduced to a sample vessel containing a sample. One or more of the lumens can introduce additional fluids to the sample, such as to dilute the sample to a specific concentration or volume, to introduce one or more chemical standards detectable by the analysis system (e.g., inductively-coupled plasma instrument (ICP), such as an ICP mass spectrometer), to introduce a reactive chemical configured to generate a chemical product detectable by the analysis system, or the like.

One or more of the lumens can introduce a mixing gas to the sample prior to during, and/or after addition of the fluids through other lumens of the sample probe to mix the fluids together to provide a substantially uniform sample prior to analysis. One or more of the lumens can draw sample from the sample vessel into the sample probe for transport to the analysis system or to another location, such as another sample vessel. The sample probe can expel gas through one or more of the lumens (e.g., the lumen(s) used to introduce mixing gas) to purge or otherwise dislodge droplets present at the tip of the sample probe. Such droplet purge operation can occur above the sample vessel after removal of the probe tip from the sample (e.g., prior to moving the probe laterally) to purge any droplets back into the sample vessel from which the droplets originated to prevent cross-contamination into another sample vessel.

### Example Implementations

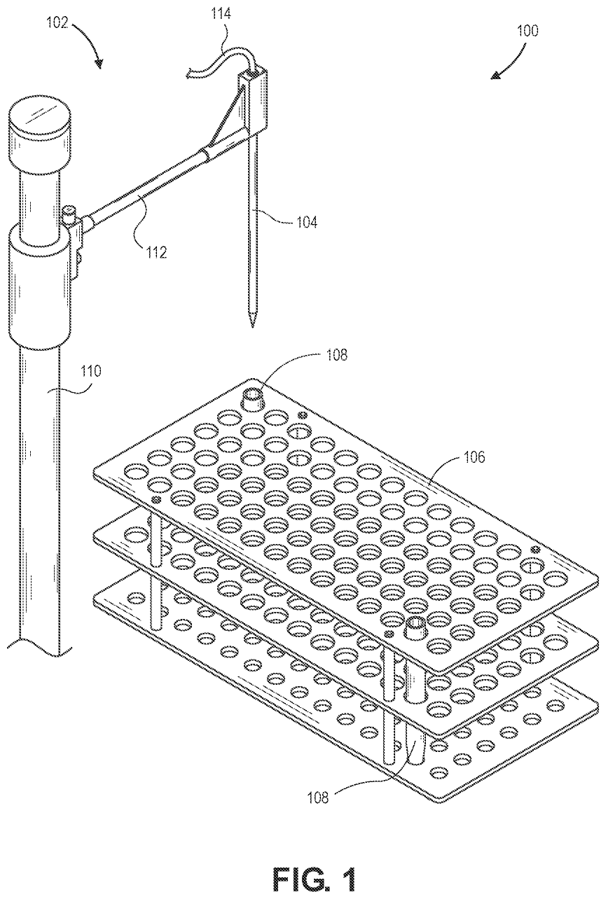

Referring to FIGS. 1 through 7, an autosampler system (“system 100”) for providing multiple lumens within a single sample probe to facilitate fluid introduction to samples, sample mixing, and sample droplet purging is shown in accordance with example embodiments of the present disclosure. The system 100 is shown generally including an autosampler arm 102 supporting a sample probe 104 positioned adjacent to a sample rack 106. The sample rack 106 is configured to hold a plurality of sample containers 108 for access by the sample probe 104. The sample containers 108 can include, but are not limited to, test tubes, vials, bottles, and other containers to hold solids, liquids, fluids, and other sample materials.

The autosampler 100 moves the autosampler arm 102 through motor control to position the sample probe 104 within the sample containers 108 to contact liquid samples within the sample containers 108 and draw (e.g., aspirate) sample into the sample probe 104 for transfer to a sample analysis system (e.g., inductively-coupled plasma instrument (ICP), such as an ICP mass spectrometer) or to another location, such as a separate sample container 108. For example, the autosampler arm 102 is shown including a z-axis support 110 and a probe support arm 112 configured to support the sample probe 104 above the sample rack 106. In implementations, the z-axis support 110 is driven via a motor (e.g., a carriage motor) which provides vertical and rotational motion of the z-axis support 110 and can also provide translational motion of the z-axis support 110 through a channel formed through the deck supporting the sample rack 106 of the system 100. The probe support arm 112 is coupled to each of the z-axis support 110 and the probe 104, such that motion of the z-axis support 110 is translated to each of the probe support arm 112 and the probe 104 to position the probe 104 relative to sample containers 108 held by the sample rack 106 (e.g., to introduce fluids to, or remove fluids from, an interior of the sample containers 108) or to position the probe 104 at a rinse station or other portion of the system 100. Example implementations of the carriage-driven z-axis support 110 are provided in U.S. patent application Ser. Nos. 14/525,531 and 17/208,136, each of which is incorporated herein by reference in its entirety.

Samples drawn from the sample containers 108 into the sample probe 104 can pass through a lumen 114 (e.g., fluid line, fluid tubing, etc.) coupled between the sample probe 104 and the sample analysis system or another location, such as another sample container 108. While FIG. 1 shows a single lumen 114, the present disclosure is not limited to a single lumen, where the lumen 114 can contain multiple fluid lines positioned within the interior of the lumen 114, multiple lumens 114 can be utilized, or combinations thereof. In implementations, the sample probe 104 includes an outer tube housing two or more lumens 114, each configured to couple with one or more fluid sources (e.g., diluents, chemical standards, reactive additives, pressurized gas sources (e.g., for mixing, for reactions, etc.), surfactant additives, matrix modifier fluids, sample matrix additives, or the like) to introduce fluids to the sample prior to drawing into the sample probe 104 for analysis by the analysis system or transfer to another location. Alternatively or additionally, the sample probe 104 can include one or more lumens 114 to carry gas to mix the sample within the sample container 108, to facilitate droplet purge operations, or combinations thereof, as described further herein. Alternatively or additionally, one or more of the lumens 114 can be utilized to draw sample into the sample probe 104 for transfer to the sample analysis system or another location.

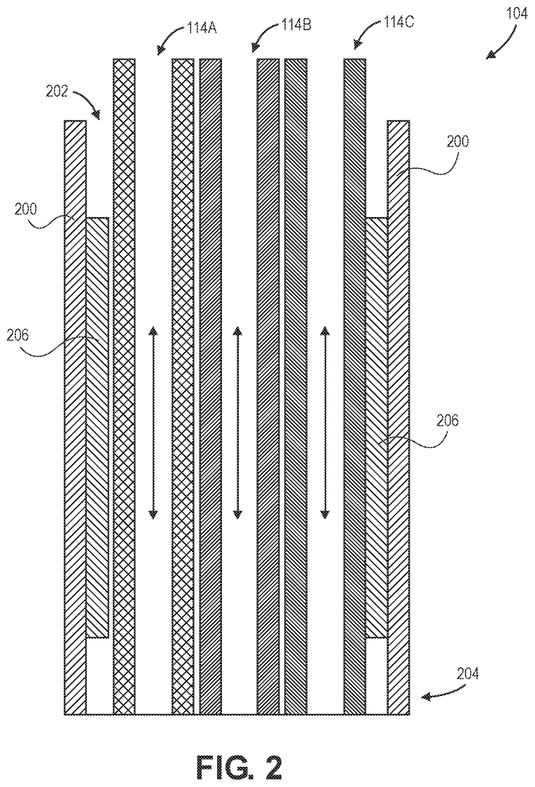

Referring to FIG. 2, the sample probe 104 is shown having a tube 200 supporting three lumens (114A, 114B, 114C) in an interior 202 of the tube 200 to introduce fluid to samples held in the sample containers 108, to introduce mixing gas to sample held in the sample containers (e.g., before fluid addition, during fluid addition, after fluid addition, and combinations thereof), and to facilitate droplet purge operations by expelling gas from one of the lumens while a tip 204 of the sample probe 104 is removed from contact with the sample held by the sample container 108. In implementations, the sample probe 104 includes a sheath 206 surrounding at least a portion of one or more of the lumens within the tube 200 to prevent substantial bending of the lumens. For instance, insertion of a sample probe into a probe support arm can cause pressure against the tube, which can tend to bend the lumens held within the tube. The sheath 206 can protect against localized deformations in the lumens 114 that would prevent fluid flow through the lumens 114 or otherwise increase pressure utilized to draw or push fluids through the lumens 114. The sheath 206 can include, but is not limited to, a carbon fiber material.

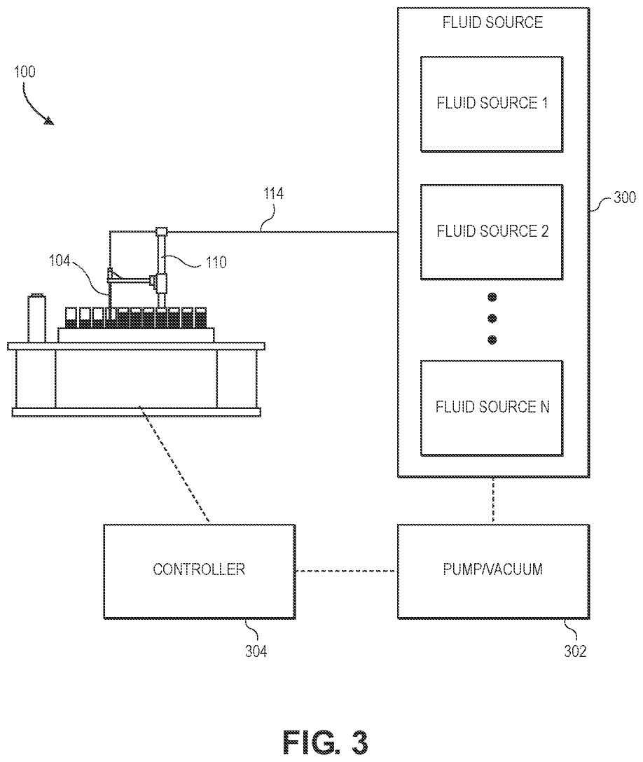

The lumens (114A, 114B, 114C) are fluidically coupled, either directly or indirectly (e.g., one or more valves, flow controllers, etc.), to one or more fluid sources or vacuum/low-pressure sources to introduce fluids to the sample probe 104 and into samples held in the sample containers 108 fluids or to draw fluids from the sample containers 108. For example, referring to FIG. 3, the system 100 is shown with the sample probe 104 fluidically coupled with a plurality of fluid sources 300 via one or more of the lumens 114. Fluids from the fluid sources 300 can be introduced to the sample probe 104 and/or drawn from the sample probe 104 via action of one or more pumps/vacuums 302 coupled with the fluid sources 300. Alternatively or additionally, the fluid sources can be pressurized and activated to introduce pressurized fluids to the sample probe 104 via activation of an intervening valve, flow meter, or the like. In implementations, the system 100 includes a controller 304 operably coupled to one or more of the autosampler arm 102 (or associated motor) and the pump/vacuum 302 to control operation of the sample probe 104, application of the fluids from the fluid sources, intervening valves, flow meters, or the like, and combinations thereof.

In implementations, each of the lumens 114A, 114B, and 114C is fluidically coupled with one or more of the fluid sources 300. For example, lumen 114A can be coupled with a first fluid source to introduce the first fluid (e.g., a diluent) to the sample via the sample probe 104, lumen 114B can be coupled with a second fluid source to introduce the second fluid (e.g., a mixing gas, such as Ar, He, N₂, etc.) to the sample via the sample probe 104 or for droplet purge operations, and lumen 114C can be interchangeably coupled between two or more fluid sources via an intervening valve to introduce the fluids to the sample via the sample probe 104. In implementations, a subset of the lumens 114A, 114B, and 114C is fluidically coupled with one or more of the fluid sources with at least one lumen coupled with the pump/vacuum 302 to aspirate or otherwise draw the sample from the sample container 108. The system 100 therefore can facilitate the addition of multiple fluids to a sample without moving the sample probe 104 from the sample, resulting in rapid sample preparation without utilizing a separate time to move the sample probe 104 or an additional device to introduce fluids to a sample. While the system 100 is shown including three lumens 114 within the tube 200, the system 100 is not limited to three lumens 114 and can include two or fewer connections with fluid sources or more than three connections with fluid sources without departing from the scope of the present disclosure. In implementations, the sample probe 104 can introduce a gas through one or more of the lumens 114 to mix the sample prior to or at the time of sample drawing to provide a mixed sample without additional time or equipment utilized to move the sample probe out of the way of mixing apparatuses.

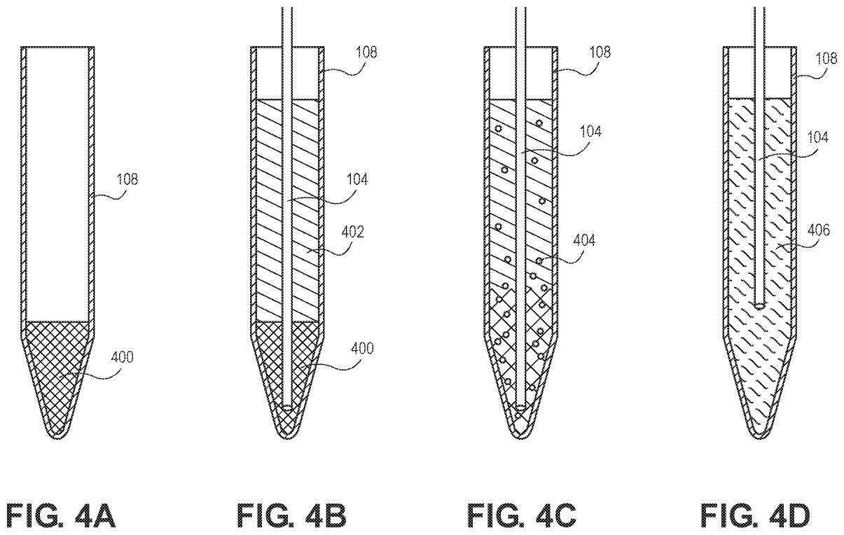

An example operation of the system 100 is described with respect to FIGS. 4A through 4D. Referring to FIG. 4A, a liquid sample 400 is held in the sample container 108, which can be positioned on a deck of the system 100, such as supported by the sample rack 106. In FIG. 4B, the sample probe 104 is introduced to the interior of the sample container 108 to dispense (e.g., via one of the lumens 114) a diluent 402 into the sample container 108. The position of the sample probe 104 and the volume of diluent 402 introduced to the sample 400 can be controlled by the controller 304, such as through control of timing of the pump 302, through operation of an intervening valve holding a specific volume of diluent, or the like. In implementations, the diluent 402 mixes with the sample 400 through fluid forces during dispensing of the diluent 402. In implementations, the system 100 provides additional mixing through introduction of a mixing gas 404 into the sample container 108 via one or more lumens 114 of the sample probe 104, such as shown in FIG. 4C. Since the sample probe 104 includes multiple lumens, the sample probe 104 can facilitate introduction of each of the diluent 402 and the mixing gas 404 without removing the sample probe 104 from the sample container 108, which permits the system 100 to operate without expending time to withdraw the sample probe 104 to begin a separate mixing process or to use a separate mixing system. Referring to FIG. 4D, a mixed sample 406 is shown in the sample container 108, where the sample probe 104 can withdraw a portion of the mixed sample 406 for transfer to a sample analysis system or to another location for additional sample preparation. For example, one of the lumens 114 can draw the mixed sample 406 into the lumen 114 through operation of the pump/vacuum 302 (e.g., through control by the controller 304).

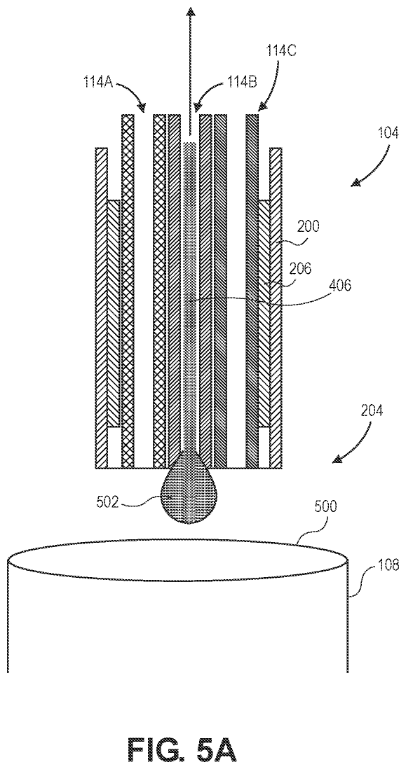

Referring to FIGS. 5A and 5B, an example droplet purge operation is shown in accordance with example embodiments of the present disclosure. In FIG. 5A, the sample probe 104 is lifted from the sample container 108 following a sample draw operation. For example, the sample probe 104 can draw the mixed sample 406 into a lumen (e.g., into lumen 114B) where the tip 204 of the sample probe 104 is subsequently lifted above the top surface of the sample, which can be above a rim 500 of the sample container 108 (e.g., shown in FIG. 5A) or between the rim 500 and the top surface of the sample (e.g., within the sample container 108). When the tip 204 of the sample probe 104 is lifted, liquid adhering to external and internal surfaces of the sample probe 104 can form a droplet 502 at the tip 204 of the sample probe 104 (e.g., at a base of the lumen 114B), which can pose a contamination risk should the droplet 502 fall during transit of the sample probe 104 (e.g., moving from the sample container 108 to a rinse station, to a next sample container 108, or the like). While the sample probe 104 facilitates transfer of the mixed sample 406, a lumen 114 of the sample probe 104 (e.g., lumen 114A) can introduce a stream of gas 504 to the tip 204, as shown in FIG. 5B, to expel the droplet 502 from the sample probe 104 and back into the sample container 108 from which the mixed sample 406 originated to prevent cross-contamination of samples.

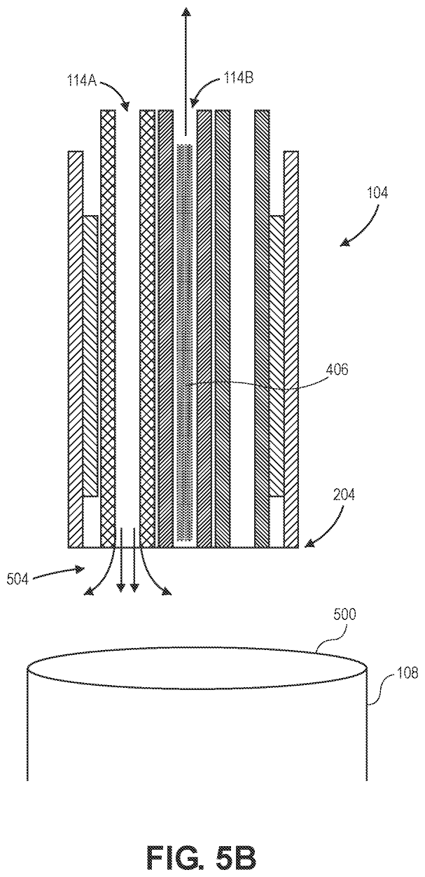

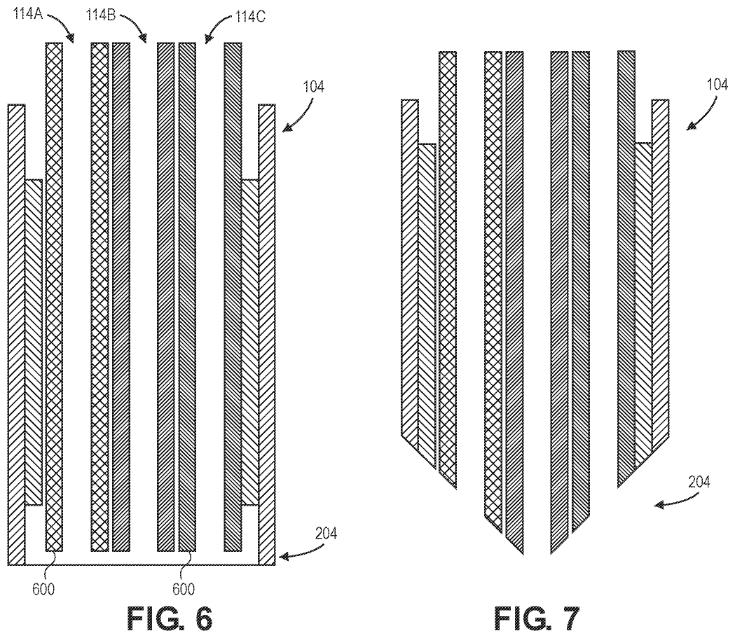

In implementations, an example of which is shown in FIG. 6, one or more of the lumens 114 of the sample probe 104 can be offset from the tip 204 of the sample probe 104. For example, the bottom tip 600 of one or more of the lumens 114 can be positioned vertically above the tip 204 of the tube 200 (e.g., as shown in FIG. 6), the bottom tip 600 of one or more of the lumens 114 can be positioned vertically below the tip 204 of the tube 200, or combinations thereof. In implementations, an example of which is shown in FIG. 7, the sample probe 104 can be formed with an angled configuration at the tip 204. For instance, the sample probe 104 can include a V-shaped tip 204 (e.g., beveled- or conical-shaped) or other angled configuration.

Electromechanical devices (e.g., electrical motors, servos, actuators, or the like) may be coupled with or embedded within the components of the system 100 to facilitate automated operation via control logic embedded within or externally driving the system 100. The electromechanical devices can be configured to cause movement of devices and fluids according to various procedures, such as the procedures described herein. The system 100 may include or be controlled by a computing system having a processor or other controller configured to execute computer readable program instructions (i.e., the control logic) from a non-transitory carrier medium (e.g., storage medium such as a flash drive, hard disk drive, solid-state disk drive, SD card, optical disk, or the like). The computing system can be connected to various components of the system 100, either by direct connection, or through one or more network connections (e.g., local area networking (LAN), wireless area networking (WAN or WLAN), one or more hub connections (e.g., USB hubs), and so forth). For example, the computing system can be communicatively coupled to the system controller, carriage motors, fluid handling systems (e.g., valves, pumps, etc.), other components described herein, components directing control thereof, or combinations thereof. The program instructions, when executed by the processor or other controller, can cause the computing system to control the system 100 (e.g., control movement of fluids via the sample probe 104, control sample mixing operations, control droplet purge operations, etc.) according to one or more modes of operation, as described herein. Alternatively or additionally, portions of the system 100 can be implemented as a handheld device, such that the sample probe 104 can be moved into position above a sample container 108 manually by a user to facilitate fluid addition, gaseous mixing, sample drawing, and combinations thereof, within and between sample containers 108.

It should be recognized that the various functions, control operations, processing blocks, or steps described throughout the present disclosure may be carried out by any combination of hardware, software, or firmware. In some embodiments, various steps or functions are carried out by one or more of the following: electronic circuitry, logic gates, multiplexers, a programmable logic device, an application-specific integrated circuit (ASIC), a controller/microcontroller, or a computing system. A computing system may include, but is not limited to, a personal computing system, a mobile computing device, mainframe computing system, workstation, image computer, parallel processor, or any other device known in the art. In general, the term “computing system” is broadly defined to encompass any device having one or more processors or other controllers, which execute instructions from a carrier medium.

Program instructions implementing functions, control operations, processing blocks, or steps, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

### CONCLUSION

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A sample probe for autosampler system comprising:
a tube enclosing at least a portion of a plurality of lumens; and
a controller communicatively coupled with a fluid handling system to introduce or draw one or more fluids through a corresponding one or more lumens among the plurality of lumens, wherein during a droplet purge operation, the controller is configured to expel a gas from a tip of one of the lumens to purge a droplet of fluid from the tip.

2. The system of claim 1, further comprising an analysis system fluidly coupled to at least one lumen among the plurality of lumens, the analysis system configured to receive a fluid for analysis via the at least one lumen.

3. The system of claim 1, further comprising a sheath disposed between at least one lumen among the plurality of lumens and the tube.

4. The system of claim 3, wherein the sheath is made of a carbon fiber material.

5. The system of claim 3, wherein the sheath resists bending of the plurality of lumens.

6. The system of claim 1, wherein the one or more fluids is a liquid.

7. The system of claim 6, wherein the one or more fluids includes at least one of: a diluent, a chemical standard, a reactive additive, a surfactant additive, a matrix modifier fluid, or a sample matrix additive.

8. The system of claim 1, wherein the one or more fluids is a gas.

9. The system of claim 8, wherein the gas includes at least one of: a diluent, a chemical standard, a reactive additive, a surfactant additive, a matrix modifier fluids, or a sample matrix additive.

10. The system of claim 1, wherein each lumen among the plurality of lumens is fluidly coupled to a respective one or more fluid sources.

11. The system of claim 10, wherein at least one lumen among the plurality of lumens is interchangeably coupled between two or more fluid sources via an intervening valve.

12. The system of claim 1, wherein a tip of one or more lumens among the plurality of lumens is offset from a tip of the tube.

13. The system of claim 1, wherein a tip of the plurality of lumens and a tip of the tube together form a beveled-shaped tip.

14. The system of claim 1, wherein a tip of the plurality of lumens and a tip of the tube together form a conical-shaped tip.

15. A method for operating a sample probe for an autosampler system comprising:
introducing a tip of the sample probe to a liquid sample held in a sample container;
introducing, via one or more lumens of the sample probe, a diluent to the liquid sample;
introducing, via the one or more lumens of the sample probe, a gas to the liquid sample, wherein the introduced gas mixes the diluent with the liquid sample; and
aspirating, via the one or more lumens, the mixed liquid sample for transfer to a sample analysis system.

16. The method of claim 15, further comprising:
removing the tip of the sample probe from the mixed liquid sample;
introducing a stream of gas, via the one or more lumens, to the tip of the sample probe, wherein the introduced stream of gas expels one or more droplets from the sample probe to reduce liquid sample cross-contamination with another sample container.

17. The method of claim 16, wherein introducing a steam of gas further includes positioning the tip of the sample probe between the mixed liquid sample and a rim of the sample container.

18. The method of claim 16, wherein the introduced stream of gas expels the one or more droplets from the sample probe into the sample container.

19. A sample probe for autosampler system comprising:
a tube enclosing at least a portion of a plurality of lumens, a tip of the tube and one or more tips corresponding to the one or more plurality of lumens together forming a conical-shaped tip;
a carbon fiber sheath disposed between the tube and at least one lumen among the plurality of lumens, the carbon fiber sheath configured to resist bending of the plurality of lumens; and
a controller communicatively coupled with a fluid handling system to introduce or draw one or more fluids through a corresponding one or more lumens among the plurality of lumens, the one or more fluids being at least one of a liquid or a gas, wherein during a droplet purge operation, the controller is configured to expel a gas from a tip of one of the lumens to purge a droplet of fluid from the tip.

20. The system of claim 19, further comprising an analysis system fluidly coupled to at least one lumen among the plurality of lumens, the analysis system configured to receive a fluid for analysis via the at least one lumen.
